(19) United States
(12) Patent Application Publication
(10) Pub. No.: US 2018/0158171 A1
(43) Pub. Date: Jun. 7, 2018

(54) DISPLAY APPARATUS AND CONTROLLING METHOD THEREOF

(71) Applicant: Samsung Electronics Co., Ltd., Suwon-si (KR)

(72) Inventors: Seok Hyun KIM, Suwon-si (KR); Chang Seog KO, Hwaseong-si (KR); Jung Geun KIM, Suwon-si (KR)

(73) Assignee: Samsung Electronics Co., Ltd., Suwon-si (KR)

(21) Appl. No.: 15/827,779

(22) Filed: Nov. 30, 2017

(30) Foreign Application Priority Data
Dec. 1, 2016 (KR) 10-2016-0163040

(51) Int. Cl. G06T 3/00; H04N 13/00; H04N 5/232; G06F 3/0481

(52) U.S. Cl. CPC G06T 3/0062; G06F 3/04815; H04N 5/23238; H04N 13/0014

(57) ABSTRACT

A display apparatus includes a display displaying a partial area of a panorama image disposed three-dimensionally, and a processor. The processor is configured to control display of a three-dimensional map corresponding to the panorama image in the display, and control display a first indicator corresponding to the partial area of the panorama image, which is displayed in the display, in the three-dimensional map.

### CROSS-REFERENCE TO RELATED APPLICATION(S)

This application claims the benefit under 35 U.S.C. § 119(a) of a Korean patent application filed on Dec. 1, 2016 in the Korean Intellectual Property Office and assigned Serial number 10-2016-0163040, the entire disclosure of which is hereby incorporated by reference.

### TECHNICAL FIELD

The present disclosure relates to a display apparatus displaying an area, which is displayed in a display, in a three-dimensional map, and a controlling method of the display apparatus.

### BACKGROUND

Virtual reality refers to any specific environment or situation that is similar to the reality created by an artificial technology using electronic devices, but is not real. A user may have an experience similar to a real experience by feeling the virtual reality by using his/her sensory organ and interacting with the virtual reality. The virtual reality technology may be easily accessed by a variety of mobile devices such as a smart phone, a tablet PCs, and the like. In recent years, as a wearable device has been commercialized, the virtual reality technology has been actively studied.

To implement the virtual reality, a camera device divides and captures an omnidirectional subject at a specific angle, and an image processing device processes the divided image to generate one panorama image obtained by capturing the omnidirectional subject.

### SUMMARY

When a panorama image obtained by capturing an omnidirectional subject is displayed to implement virtual reality, the partial area of the panorama image may be displayed in a display. In this case, it is difficult for a user to know which area of the area of the panorama image is displayed on the display.

When the partial area of the panorama image is displayed in the display, it is difficult for the user to know information about an area, which is not displayed in the display, of the area of the panorama image. Accordingly, if the main scene is included in the area that is not displayed in the display, the user may miss it.

Various embodiments of the present disclosure provide a display apparatus that displays a three-dimensional map in a display to provide information about a panorama image displayed in the display, and a controlling method of the display apparatus.

In accordance with an aspect of the present disclosure, a display apparatus includes a display displaying a partial area of a panorama image disposed three-dimensionally, and a processor. The processor is configured to control display of a three-dimensional map corresponding to the panorama image by the display, and control display a first indicator corresponding to the partial area of the panorama image, by the display, in the three-dimensional map.

In accordance with another aspect of the present disclosure, a controlling method of a display apparatus includes displaying a partial area of a panorama image disposed three-dimensionally in a display, displaying a three-dimensional map corresponding to the panorama image in the display, and displaying a first indicator corresponding to the partial area, which is displayed in the display, in the three-dimensional map.

Other aspects, advantages, and salient features of the disclosure will become apparent to those skilled in the art from the following detailed description, which, taken in conjunction with the annexed drawings, discloses various embodiments of the present disclosure.

According to an embodiment of the present disclosure, if displaying a partial area of a panorama image obtained by capturing an omnidirectional subject in a display, a display apparatus may display a three-dimensional map corresponding to the panorama image in the display, and may display the partial area of the panorama image, which is displayed in the display in a vertical direction as well as a horizontal direction, in the three-dimensional map. Accordingly, a user may easily recognize an area, which is displayed in the display, of the area of the panorama image.

In addition, the display apparatus may display a coordinate of a key area of the panorama image in the three-dimensional map, and then the user may recognize information about an area, which is not displayed in the display, of the area of the panorama image.

Besides, a variety of effects directly or indirectly understood through this disclosure may be provided.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a display system, according to various embodiments of the present disclosure;

FIG. 2 is a block diagram illustrating a configuration of a display apparatus, according to various embodiments of the present disclosure;

FIGS. 3A and 3B illustrate a panorama image, according to an embodiment of the present disclosure;

FIGS. 4A and 4B illustrate displaying an indicator corresponding to a partial area, which is displayed in a display, in a three-dimensional map, according to an embodiment of the present disclosure;

FIGS. 5A and 5B illustrate a process of controlling a first indicator of a three-dimensional map by using a direction key, according to an embodiment of the present disclosure;

FIGS. 6A, 6B, and 6C illustrate a process of controlling a first indicator of a three-dimensional map by using a mouse pointer, according to an embodiment of the present disclosure;

FIG. 7 illustrates displaying designation of a key area, according to an embodiment of the present disclosure;

FIG. 8 illustrates displaying an indicator corresponding to a specified coordinate of a panorama image in a three-dimensional map, according to an embodiment of the present disclosure;

FIG. 9 illustrates displaying indicators, which correspond to a plurality of coordinates of a panorama image, of a three-dimensional map, according to an embodiment of the present disclosure;

FIG. 10 illustrates a form in which a second indicator of a three-dimensional map is displayed, according to an embodiment of the present disclosure; and

FIG. 11 is a flowchart illustrating a controlling method of a display apparatus, according to various embodiments of the present disclosure.

Throughout the drawings, it should be noted that like reference numbers are used to depict the same or similar elements, features, and structures.

### DETAILED DESCRIPTION

Hereinafter, various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar elements may be marked by similar reference numerals.

In this disclosure, the expressions “have”, “may have”, “include” and “comprise”, or “may include” and “may comprise” used herein indicate existence of corresponding features (e.g., elements such as numeric values, functions, operations, or components) but do not exclude presence of additional features.

In this disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in this disclosure may be used to refer to various elements regardless of the order and/or the priority and to distinguish the relevant elements from other elements, but do not limit the elements. For example, “a first user device” and “a second user device” indicate different user devices regardless of the order or priority. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used in this disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in this disclosure are used to describe specified embodiments and are not intended to limit the scope of the present disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of this disclosure. In some cases, even if terms are terms which are defined in this disclosure, they may not be interpreted to exclude embodiments of this disclosure.

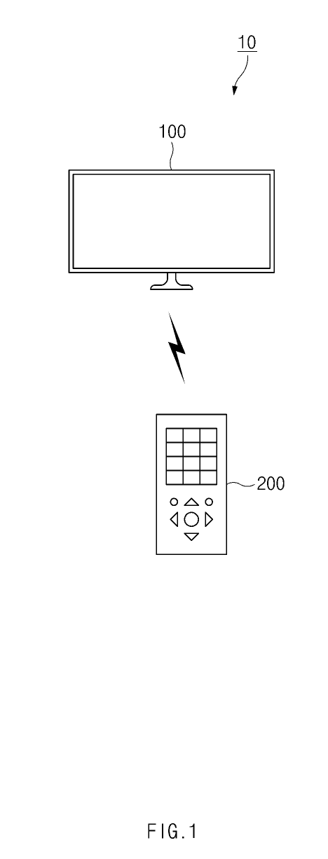

FIG. 1 is a view illustrating a display system, according to various embodiments of the present disclosure.

Referring to FIG. 1, a display system 10 may include a display apparatus 100 and a remote control device 200. The display system 10 may display a panorama image in the display apparatus 100. For example, the panorama image may be an image that is obtained by capturing an omnidirectional subject with the center at a camera device capturing the panorama image. The camera device may include a plurality of camera modules, and the plurality of camera modules may divide and capture an omnidirectional image depending on a specified angle. The divided and captured image may become the panorama image by being stitched with each other.

According to an embodiment, the display apparatus 100 may display the partial area of the panorama image in a display. The display apparatus 100 may receive a user input from a user and may display the partial area of the panorama image in the display depending on the user input. For example, the display apparatus 100 may receive the user input through an input unit of the remote control device 200 or the display apparatus 100 and may display the partial area of the panorama image in the display depending on the user input. For another example, in the case where the display apparatus 100 is a wearable device such as a head mounted display (HMD) or the like, the display apparatus 100 may sense a head direction of the user and may display the partial area of the panorama image in the display depending on the head direction.

The remote control device 200 may be connected to the display apparatus 100 and may transmit the user input to the display apparatus 100. For example, the remote control device 200 may be connected to the display apparatus 100 through a short range wireless communication interface such as Bluetooth, near field communication (NFC), an infrared (IR) transceiver, or the like and may transmit the user input to the display apparatus 100.

The display apparatus 100 may implement virtual reality by displaying the partial area of the omnidirectional image in the display depending on the user input. Since the display apparatus 100 displays the partial area of the panorama image, it is difficult for the user to know which area of the area of the panorama image is displayed in the display, and it is difficult for the user to know information about an area, which is not displayed in the display, of the area of the panorama image. Accordingly, if displaying only the partial area of the panorama image in the display depending on the user input, the display apparatus 100 may fail to provide a user interface (UI) and a user experience (UX) convenient to the user. According to various embodiments of the present disclosure, the display apparatus 100 may display a three-dimensional map corresponding to the panorama image in the display to provide the user with information about the panorama image.

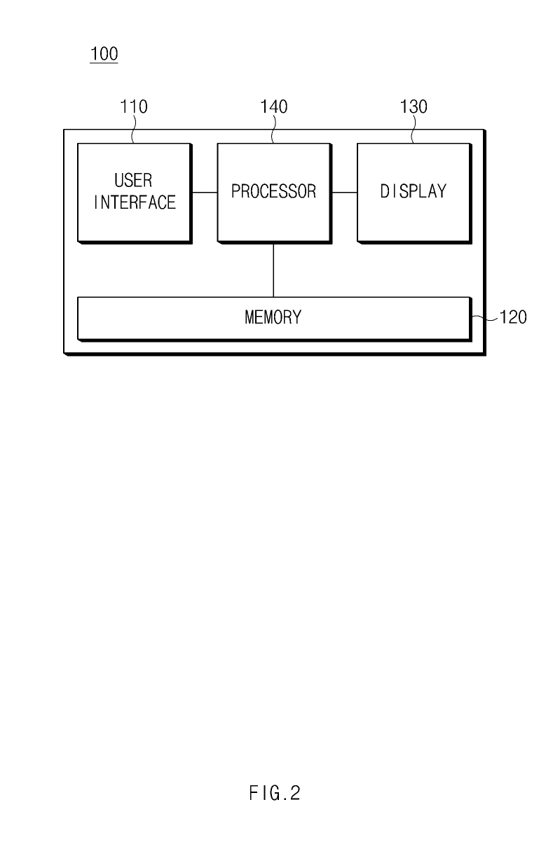

FIG. 2 is a block diagram illustrating a configuration of a display apparatus, according to various embodiments of the present disclosure.

Referring to FIG. 2, the display apparatus 100 may include a user interface 110, a memory 120, a display 130, and a processor 140.

The user interface 110 may receive a user input through an input device such as the remote control device 200, a mouse, a touch screen, a motion sensor, or the like. For example, the user interface 110 may receive a user input for displaying the partial area of a panorama image in the display 130.

According to an embodiment, the user interface 110 may receive a user input for controlling the indicator of a three-dimensional map. For example, the user interface 110 may receive the user input for controlling the indicator through the remote control device 200. The user interface 110 may control the indicator of the three-dimensional map depending on the user input to change an area, which is displayed in the display 130, of the area of the panorama image.

The memory 120 may store the panorama image and information about the panorama image. For example, the panorama image may be a video image including a still image. The still image may be the frame of the panorama image. The information about the panorama image may include at least one of coordinate information and time information of the panorama image. The processor 140 may display an indicator in the three-dimensional map based on the coordinate information and the time information. For example, the memory 120 may be a nonvolatile memory such as a flash memory or a hard disk.

The display 130 may display the partial area of the panorama image. For example, the display 130 may display the partial area of the panorama image in a display depending on the received user input.

The processor 140 may control overall operations of the display apparatus 100. For example, the processor 140 may receive the user input through the user interface 110 and may display the partial area of the panorama image stored in the memory 120 in the display 130 depending on the user input.

According to an embodiment, the display apparatus 100 may include at least one processor 140. For example, the display apparatus 100 may include a plurality of processors 140 capable of executing at least one function. According to an embodiment, the processor 140 may be implemented with a system on chip (SoC) that includes a central processing unit (CPU), a graphic processing unit (GPU), a memory, and the like.

According to an embodiment, the processor 140 may display the three-dimensional map corresponding to the panorama image in the display 130. For example, the processor 140 may display an area, which is displayed in the display 130, of the area of the panorama image in the three-dimensional map. For another example, the processor 140 may display a specific coordinate of the panorama image in the three-dimensional map.

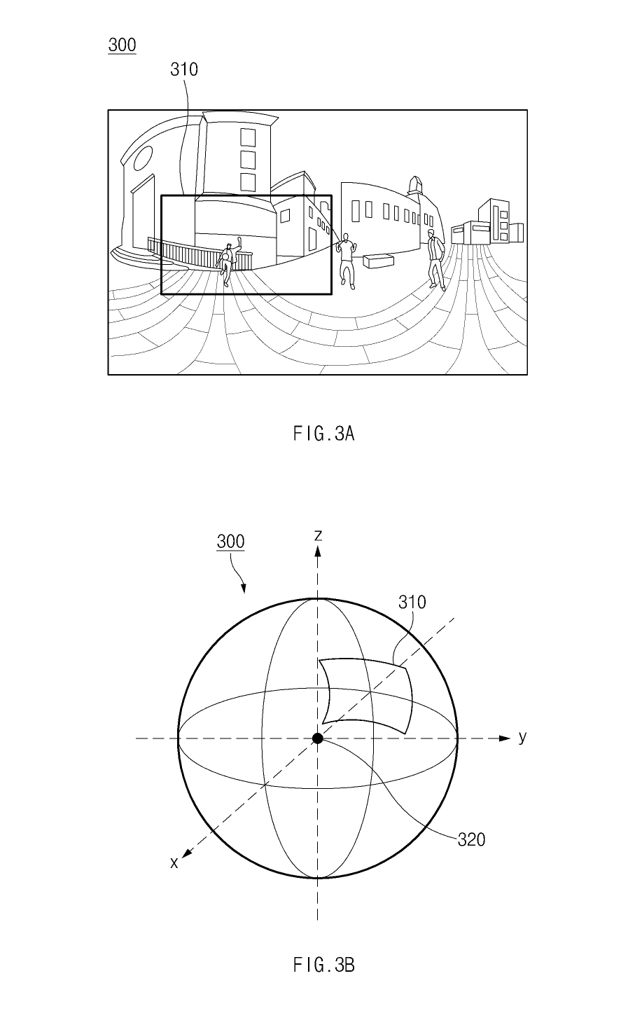

FIGS. 3A and 3B illustrate a panorama image, according to an embodiment of the present disclosure.

Referring to FIGS. 3A and 3B, a panorama image 300 may be an image obtained by capturing an omnidirectional subject with the center at a camera device capturing the panorama image 300. For example, the panorama image 300 may be disposed and formed two-dimensionally by stitching plurality of divided and captured images. Alternatively, the panorama image 300 may be formed three-dimensionally by disposing a two-dimensional image three-dimensionally. For example, the panorama image 300 disposed two-dimensionally may be disposed on a spherical surface with the center at a capture point 320 of the panorama image 300.

According to an embodiment, the processor 140 of the display apparatus 100 may display a partial area 310 of the panorama image 300 in the display 130. For example, the processor 140 may display the partial area 310 of the panorama image 300, which is disposed three-dimensionally, in the display 130 depending on the user input received through the user interface 110.

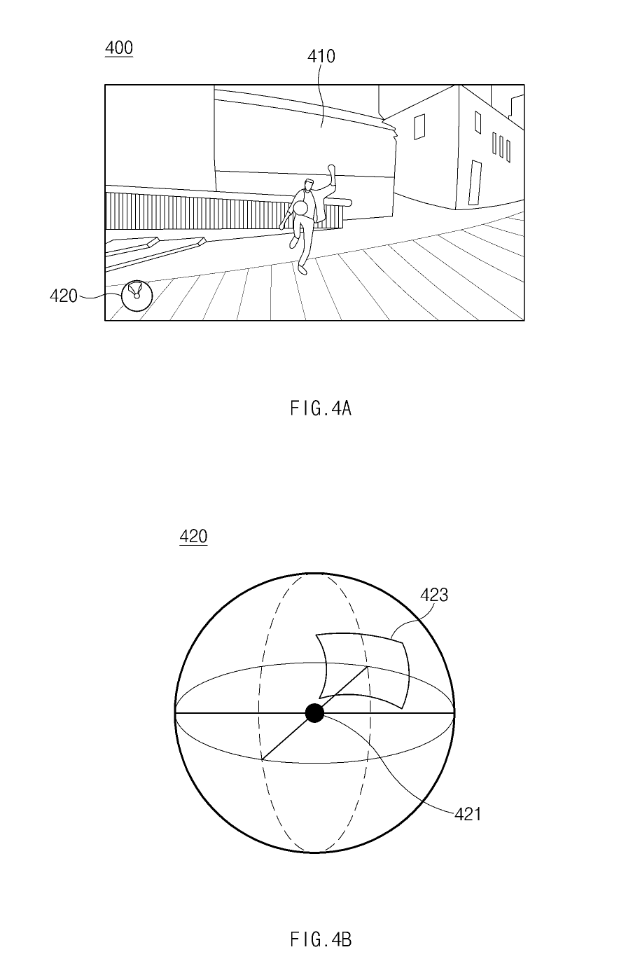

FIGS. 4A and 4B illustrate displaying an indicator corresponding to a partial area, which is displayed in a display, in a three-dimensional map, according to an embodiment of the present disclosure.

Referring to FIG. 4A, a screen 400 displayed in the display 130 may include a display image 410 and a three-dimensional map 420. The processor 140 of the display apparatus 100 may display the partial area 310 of the panorama image 300 and the three-dimensional map 420 in the display 130.

The display image 410 may be the partial area 310 of the panorama image 300 selected depending on a user input. The processor 140 of the display apparatus 100 may display the partial area 310 of the panorama image 300 in the display 130 depending on the user input.

The three-dimensional map 420 may be a shape corresponding to the panorama image 300 disposed three-dimensionally. For example, the three-dimensional map 420 may be a spherical shape corresponding to the panorama image 300 disposed on a spherical surface.

According to an embodiment, a user's viewpoint 421 of the three-dimensional map 420 may correspond to the capture point 320 of the panorama image 300. For example, the user's viewpoint 421 may be located at the center of the three-dimensional map 420, and the center of the three-dimensional map 420 may correspond to the center of the panorama image 300.

According to an embodiment, the three-dimensional map 420 may include a first indicator 423 for indicating the display image 410. The first indicator 423 may correspond to the partial area 310 of the panorama image 300 displayed in the display 130. For example, the first indicator 423 may be displayed in the partial area of the three-dimensional map 420 corresponding to the partial area displayed in the display 130. The whole area of the three-dimensional map 420 may correspond to the panorama image 300; the first indicator 423 may be displayed in the partial area of the three-dimensional map 420 such that the size of the first indicator 423 is proportional to the size of an area, which is displayed in the display 130, of the area of the panorama image 300. Accordingly, if the display image 410 is changed depending on the user input, a size, a shape, a location, or the like of the first indicator 423 of the three-dimensional map 420 may be changed to correspond to the display image 410.

According to an embodiment, the location of the first indicator 423 of the three-dimensional map 420, at which the first indicator 423 is displayed in the three-dimensional map 420, may be determined depending on a specified method. For example, the location of the first indicator 423 displayed in the three-dimensional map 420 may be determined based on a coordinate of the panorama image 300. For another example, the location of the first indicator 423, at which the first indicator 423 is displayed in the three-dimensional map 420, may be determined based on the location at which the first indicator 423 is displayed first in the three-dimensional map 420.

According to an embodiment, the three-dimensional map 420 may include a guide line displayed at a location of a principal angle. For example, the guide line may include horizontal and vertical lines that respectively indicate horizontal and vertical positions. Accordingly, when the first indicator 423 is displayed in the three-dimensional map 420, the location of the first indicator 423 may be displayed clearly.

According to an embodiment, the processor 140 of the display apparatus 100 may control the first indicator 423 depending on the user input received through the user interface 110 to change an image displayed in the display 130. For example, the processor 140 may change at least one of a location, a size, and a shape of the first indicator 423 to change an image displayed in the display 130.

According to an embodiment, the processor 140 may control the location of the first indicator 423 to change an image displayed in the display 130.

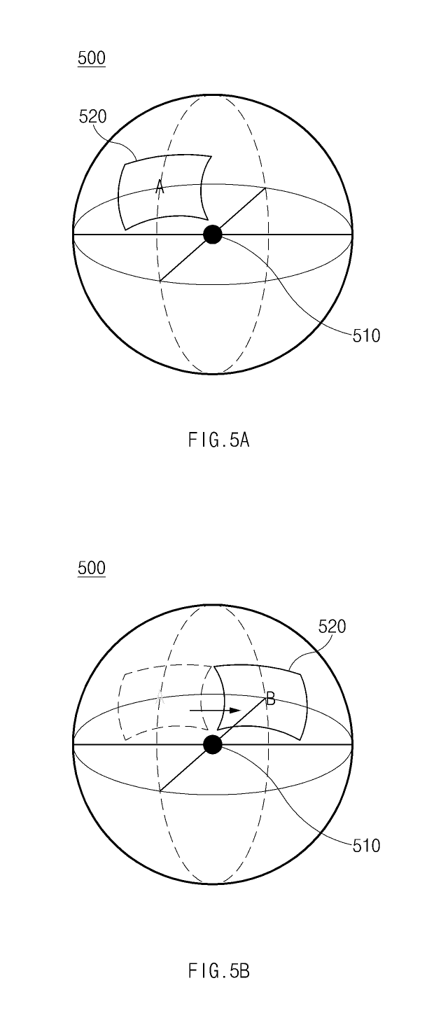

FIGS. 5A and 5B illustrate a process of controlling a location of a first indicator of a three-dimensional map by using a direction key, according to an embodiment of the present disclosure.

Referring to FIGS. 5A and 5B, the processor 140 may receive a user input that is input through a direction key (e.g., a direction key of the remote control device 200) and may control the location of a first indicator 520 of a three-dimensional map 500 depending on the user input. For example, the processor 140 may move the location of the first indicator 520 from a first location A to a second location B with the center at a user's viewpoint 510 of the three-dimensional map 500 depending on the user input. Accordingly, the location of the image displayed in the display 130 may be changed from an image of an area, which corresponds to the first indicator 520 of the first location A, of an area of the panorama image 300 to an image corresponding to the first indicator 520 of the second location B.

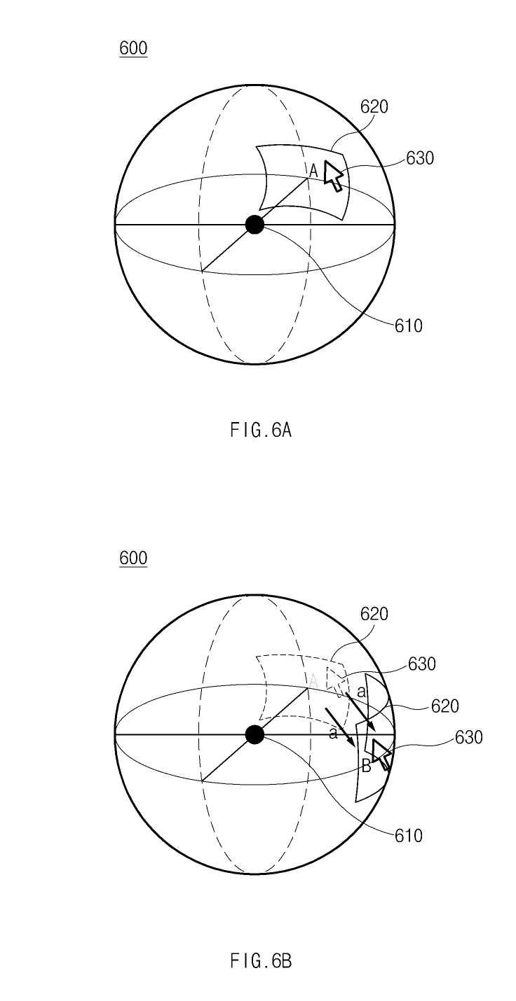

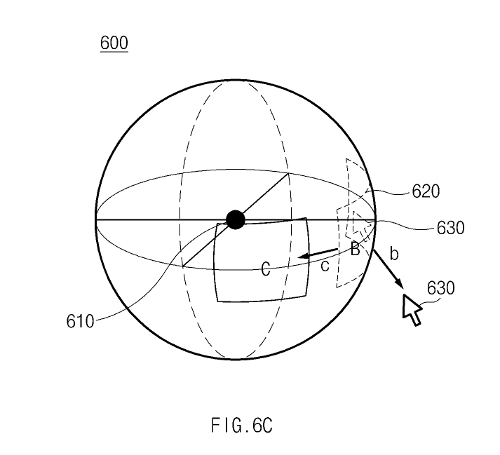

FIGS. 6A, 6B, and 6C illustrate a process of controlling a first indicator of a three-dimensional map by using a mouse pointer, according to an embodiment of the present disclosure.

Referring to FIGS. 6A, 6B, and 6C, the processor 140 may receive a user input that is input by using a mouse pointer 630, and may control the location of a first indicator 620 of a three-dimensional map 600 depending on the user input. For example, the user may drag the first indicator 620 to the desired location of the three-dimensional map 600 by using the mouse pointer 630.

According to an embodiment, the first indicator 620 may be dragged to a first location A (e.g., from a rear surface (or front surface) of the three-dimensional map 600) to a second location B (e.g., a side surface of the three-dimensional map 600) with the center at the user's viewpoint 610 of the three-dimensional map 600. For example, the user may move the mouse pointer 630 in a first direction “a” from the interior of the three-dimensional map 600; the first indicator 620 may be moved to the second location B by being dragged in a direction “a” similar to the first direction “a”.

According to an embodiment, the first indicator 620 may be dragged from the second location B (e.g., from the side surface of the three-dimensional map 600) to a third location C (e.g., the front surface (or rear surface) of the three-dimensional map 600) with the center at the user's viewpoint 610 of the three-dimensional map 600. For example, the user may move the mouse pointer 630 in a second direction “b” facing the outside, from the interior of the three-dimensional map 600; the first indicator 620 may be moved to the third location C by being dragged in a direction “c” different from the second direction “b”.

Accordingly, since the front surface and the rear surface of the three-dimensional map 600 are displayed at the same pixels on a screen of the display 130, the processor 140 may determine whether the first indicator 620 is dragged from the front surface of the three-dimensional map 600 to the rear surface thereof or from the rear surface thereof to the front surface thereof, in consideration of whether the mouse pointer 630 moves from inside to outside.

According to an embodiment, the processor 140 may control the size of the first indicator 620 to change an image displayed in the display 130. For example, the processor 140 may receive a user input for controlling the size of the first indicator 620 and may increase or decrease the size of the first indicator 620 depending on the user input. Accordingly, the image displayed in the display 130 may be changed from an image of an area, which corresponds to the first indicator 620 before the size is changed, of the area of the panorama image 300 to an image of an area corresponding to the first indicator 620 after the size is changed.

According to an embodiment, the processor 140 may control the shape of the first indicator 620 to change an image displayed in the display 130. For example, the processor 140 may receive a user input for controlling the shape of the first indicator 620 and may change (e.g., change the shape from a square to a rectangle) the shape of the first indicator 620 depending on the user input. Accordingly, the image displayed in the display 130 may be changed from an image of an area, which corresponds to the first indicator 620 before the shape is changed, of the area of the panorama image 300 to an image of an area corresponding to the first indicator 620 after the shape is changed.

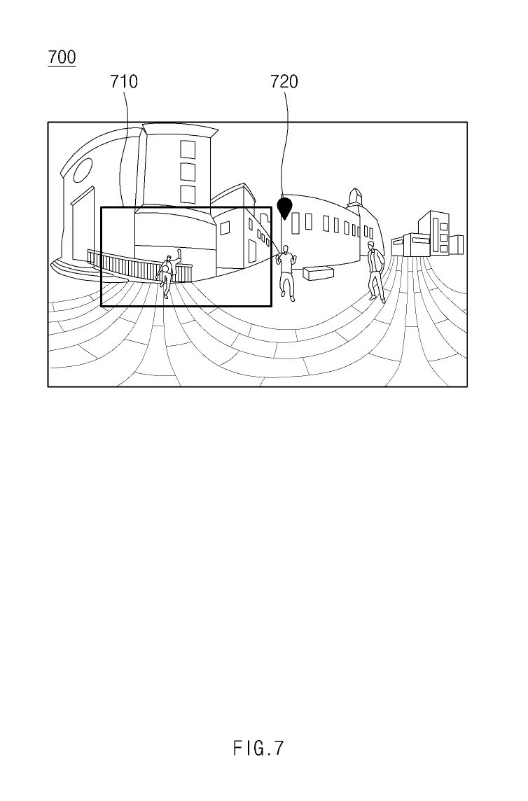

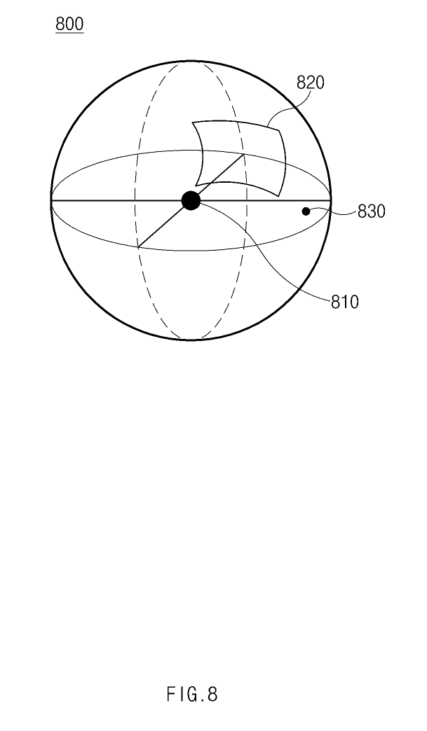

FIGS. 7 and 8 illustrate displaying an indicator corresponding to a specified coordinate of a panorama image in a three-dimensional map, according to an embodiment of the present disclosure.

Referring to FIG. 7, a panorama image 700 may be an image obtained by capturing an omnidirectional subject and may be disposed three-dimensionally. The processor 140 of the display apparatus 100 may display the partial area 710 of the panorama image 700 in the display 130 depending on a user input.

According to an embodiment, the panorama image 700 may include a specified coordinate 720 of a key area. For example, the key area may be an area, which a user or the like desires to display in the display 130, of the area of the panorama image 700.

According to an embodiment, information about the specified coordinate 720 may be included in information about the panorama image 700. For example, the photographer of the panorama image 700, the user, or the like may designate a specific coordinate, and the information about the specified coordinate 720 may be included or stored in the information about the panorama image 700.

According to an embodiment, the processor 140 of the display apparatus 100 may analyze a panorama image to verify the specified coordinate 720 satisfying a specified condition. For example, the specified condition may be that a specified object (e.g., a person) of the panorama image 700 is recognized. For example, in the case where the specified object is a person, the processor 140 may recognize the person's face to verify the specified coordinate 720. For another example, in the case where the panorama image 700 is a video image, the specified condition may be that a pixel value of each of pixels of the specified number of the panorama image 700 is changed during a specified time.

Referring to FIG. 8, a three-dimensional map 800 may be a shape corresponding to the panorama image 700 disposed three-dimensionally. The user's viewpoint 810 of the three-dimensional map 800 may correspond to the capture point of the panorama image 700. A first indicator 820 of the three-dimensional map 800 may correspond to the partial area 710 of the panorama image 700 displayed in the display 130.

According to an embodiment, the processor 140 of the display apparatus 100 may display a second indicator 830 at a location, which corresponds to the specified coordinate 720 of the panorama image 700, of the three-dimensional map 800. For example, the processor 140 may display the second indicator 830 at a location, which corresponds to specified coordinate information included in the information about the panorama image 700, of the three-dimensional map 800. For another example, the processor 140 may analyze the panorama image 700 to verify the specified coordinate 720 satisfying a specified condition, and may display the second indicator 830 at a location, which corresponds to the specified coordinate 720, of the three-dimensional map 800. Accordingly, the processor 140 may display information about the key area in the three-dimensional map 800 to provide the user.

According to an embodiment, if an input to the second indicator 830 is received through the user interface 110, the processor 140 may display an area (e.g., a key area), which includes a coordinate corresponding to the second indicator 830, of the area of the panorama image 700, in the display 130. For example, the input to the second indicator 830 may be an input for changing an image displayed in the display 130 by changing the location of the first indicator 820 to a location of an area in which the second indicator 830 of the three-dimensional map 800 is included. For example, the input about the second indicator 830 may be input through the remote control device 200. Accordingly, the processor 140 may rapidly display the key area of the panorama image 700 in the display 130 to provide the user.

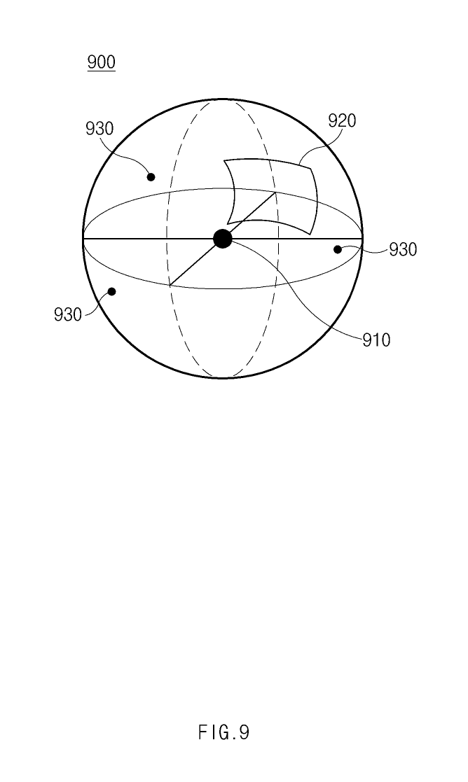

FIG. 9 illustrates displaying indicators, which correspond to a plurality of coordinates of a panorama image, of a three-dimensional map, according to an embodiment of the present disclosure.

Referring to FIG. 9, a three-dimensional map 900 may be a shape corresponding to a panorama image. A user's viewpoint 910 of the three-dimensional map 900 may correspond to the capture point of the panorama image. A first indicator 920 of the three-dimensional map 900 may correspond to the partial area of the panorama image displayed in the display 130.

According to an embodiment, the processor 140 of the display apparatus 100 may display a plurality of second indicators 930 at locations, which correspond to a plurality of specified coordinates of the panorama image, of the three-dimensional map 900. For example, information about the panorama image may include information about a plurality of specified coordinates. For another example, the processor 140 may analyze the panorama image to verify the plurality of specified coordinates satisfying a specified condition.

According to an embodiment, if an input to the second indicators 930 is received through the user interface 110, the processor 140 may sequentially display a plurality of areas, which respectively include coordinates corresponding to the plurality of second indicators 930, of the area of the panorama image in the display 130. For example, the processor 140 may sequentially display a plurality of areas, which include coordinates corresponding to the second indicators 390, of the area of the panorama image in the display 130 in order of distances to the second indicators 930 from an area, in which the first indicator 920 is displayed. For example, the processor 140 may sequentially display a plurality of areas, which include coordinates corresponding to the second indicators 390, of the area of the panorama image in the display 130 on a specified plane in a clockwise or counterclockwise direction based on the first indicator 920 of the panorama image. Accordingly, the processor 140 may rapidly display a plurality of key areas of the panorama image in the display 130 to provide the user.

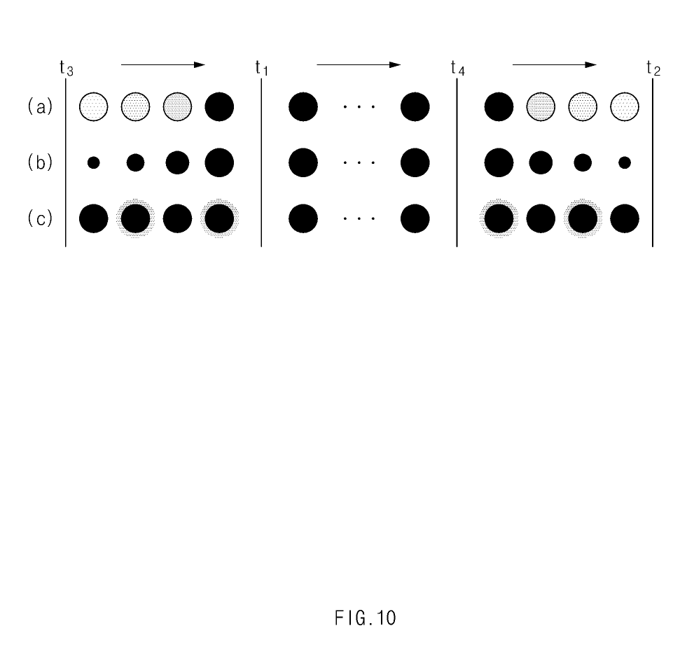

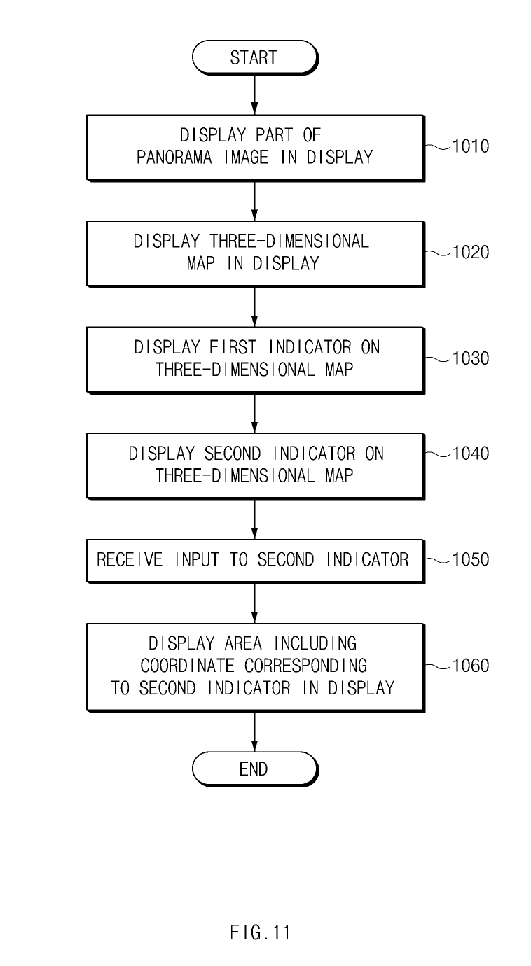

FIG. 10 illustrates a form in which a second indicator of a three-dimensional map is displayed, according to an embodiment of the present disclosure.

Referring to FIG. 10, a panorama image may be a video image and may include a plurality of still images. The panorama image may include a specified coordinate of a key area, and the processor 140 of the display apparatus 100 may display a second indicator at a specified coordinate of the panorama image from a first time t1 to a second time t2.

According to an embodiment, the processor 140 may display the second indicator from the third time t3 earlier than the first time t1. For example, the third time t3 may be a time “t1−ts” before a specified time ts from the first time t1. For example, the specified time ts may be designated by a user input in consideration of a time for displaying an area, which includes a coordinate corresponding to the second indicator, of the area of a panorama image in the display 130.

According to an embodiment, when displaying the second indicator in the three-dimensional map from the third time t3 to the first time t1, the processor 140 may change and display at least one of a transparency, a size, a display period, a color, and a shape of the second indicator. For example, as the first time t1 approaches, the processor 140 may decrease the transparency of the second indicator (a). For another example, as the first time t1 approaches, the processor 140 may increase the size of the second indicator (b). For another example, as the first time t1 approaches, the processor 140 may periodically change the shape of the second indicator (c).

According to an embodiment, the processor 140 may change and display at least one of the transparency, the size, the display period, the color, and the shape of the second indicator from the fourth time t4 that is earlier than the second time t2 and is later than the first time t1. For example, as the second time t2 approaches, the processor 140 may increase the transparency of the second indicator (a). For another example, as the second time t2 approaches, the processor 140 may decrease the size of the second indicator (b). For another example, as the second time t2 approaches, the processor 140 may periodically change the shape of the second indicator (c).

According to an embodiment, the processor 140 may display a plurality of the second indicators, which are to be displayed in the three-dimensional map at different time points. If an input to the second indicators is received through the user interface 100, the processor 140 may sequentially display a plurality of areas, which respectively include coordinates corresponding to the plurality of second indicators, of the area of the panorama image in the display 130. For example, the processor 140 may sequentially display a plurality of areas, which respectively include coordinates corresponding to the plurality of second indicators, of the area of the panorama image in the display 130 in order of time points when the display of the second indicators is started.

Accordingly, the processor 140 may display at least one of a display time of the second indicators and a time when the second indicators end, in the three-dimensional map to provide a user with a notification for the display time of the second indicators, and may rapidly display a plurality of key areas of the panorama image in the display 130 to provide the user.

According to an embodiment of the present disclosure given with reference to FIGS. 1 to 10, if displaying a partial area of a panorama image obtained by capturing an omnidirectional subject in the display 130, the display apparatus 100 may display the three-dimensional map corresponding to the panorama image in the display 130, and may display the partial area of the panorama image, which is displayed in the display 130 by using a vertical direction as well as a horizontal direction, in the three-dimensional map. Accordingly, a user may easily recognize an area, which is displayed in the display 130, of the area of the panorama image.

In addition, the display apparatus 100 may display a coordinate of a key area of the panorama image in the three-dimensional map, and then the user may recognize information about an area, which is not displayed in the display 130, of the area of the panorama image.

FIG. 11 is a flowchart illustrating a controlling method of a display apparatus, according to various embodiments of the present disclosure.

The flowchart illustrated in FIG. 11 may be composed of operations processed by the above-described display apparatus 100, and may illustrate a controlling method of the display apparatus 100 for displaying a three-dimensional map in the display 130. Even though omitted below, details about the display apparatus 100 given with reference to FIGS. 1 to 10 may be applied to the flowchart illustrated in FIG. 11.

According to an embodiment, in operation 1010, the display apparatus 100 may display a partial area of a panorama image in the display 130. For example, the display apparatus 100 may receive a user input and may display the partial area of the panorama image in the display 130 depending on the user input.

According to an embodiment, in operation 1020, the display apparatus 100 may display the three-dimensional map in the display 130. For example, the display apparatus 100 may display the three-dimensional map corresponding to the panorama image in the display 130.

According to an embodiment, in operation 1030, the display apparatus 100 may display a first indicator in the three-dimensional map. For example, the display apparatus 100 may display the first indicator corresponding to the partial area of the panorama image displayed in the display 130, in the three-dimensional map.

According to an embodiment, in operation 1040, the display apparatus 100 may display a second indicator in the three-dimensional map. The display apparatus 100 may display the second indicator at a location corresponding to a specified coordinate of the key area of the panorama image. For example, the display apparatus 100 may display the second indicator at a location corresponding to specified coordinate information included in information about the panorama image. For another example, the display apparatus 100 may analyze the panorama image to verify the specified coordinate satisfying a specified condition and may display the second indicator at a location corresponding to the specified coordinate. The display apparatus 100 may display the second indicator from the first time t1 to the second time t2.

According to an embodiment, in operation 1050, the display apparatus 100 may receive an input to the second indicator (or an input which is associated with the second indicator). For example, the display apparatus 100 may receive the input to the second indicator for changing an image displayed in the display 130.

According to an embodiment, in operation 1160, the display apparatus 100 may display an area, which includes a coordinate corresponding to the second indicator, of the area of the panorama image in the display 130.

The term “module” used in this disclosure may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments may be, for example, implemented by instructions stored in a computer-readable storage media in the form of a program module. The instruction, when executed by a processor (e.g., the processor 140 of FIG. 2), may cause the one or more processors to perform a function corresponding to the instruction. The computer-readable storage media, for example, may be the memory 130 of FIG. 2.

A computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and hardware devices (e.g., a read only memory (ROM), a random access memory (RAM), or a flash memory). Also, a program instruction may include not only a mechanical code such as things generated by a compiler but also a high-level language code executable on a computer using an interpreter. The above hardware unit may be configured to operate via one or more software modules for performing an operation according to various embodiments, and vice versa.

A module or a program module according to various embodiments may include at least one of the above elements, or a part of the above elements may be omitted, or additional other elements may be further included. Operations performed by a module, a program module, or other elements according to various embodiments may be executed sequentially, in parallel, repeatedly, or in a heuristic method. In addition, some operations may be executed in different sequences or may be omitted. Alternatively, other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A display apparatus comprising:
a display configured to display a partial area of a panorama image disposed three-dimensionally; and
a processor configured to:
control display of a three-dimensional map corresponding to the panorama image by the display; and
control display of a first indicator corresponding to the partial area of the panorama image, by the display, in the three-dimensional map.

2. The display apparatus of claim 1, wherein the panorama image is disposed on a spherical surface, and
wherein the three-dimensional map is in a spherical shape.

3. The display apparatus of claim 1, wherein the indicator is displayed in a partial area of the three-dimensional map corresponding to the partial area of the panorama image displayed in the display.

4. The display apparatus of claim 1, further comprising:
a user interface configured to receive a user input,
wherein the processor is configured to:
change one or more of a size, a shape, and a location of the first indicator depending on the user input received through the user interface; and
change an image displayed in the display, depending on the changed first indicator.

5. The display apparatus of claim 1, wherein the processor is configured to:
display a second indicator at a location, which corresponds to a specified coordinate of the panorama image, of the three-dimensional map.

6. The display apparatus of claim 5, wherein the processor is configured to:
display the second indicator at a location, which corresponds to specified coordinate information included in information about the panorama image, of the three-dimensional map.

7. The display apparatus of claim 5, wherein the processor is configured to:
analyze the panorama image to verify the specified coordinate satisfying a specified condition; and
display the second indicator at a location, which corresponds to the specified coordinate, of the three-dimensional map.

8. The display apparatus of claim 7, wherein the specified condition is that pixel values of pixels of a specified number in the panorama image are changed during a specified time or that a specified object is recognized in the panorama image.

9. The display apparatus of claim 5, further comprising:
a user interface configured to receive a user input,
wherein the processor is configured to:
upon receipt of the user input which is associated with the second indicator through the user interface, display an area, which includes a coordinate corresponding to the second indicator, of an area of the panorama image in the display.

10. The display apparatus of claim 5, wherein the processor is configured to:
display the second indicator from a first time to a second time based on specified time information included in information about the panorama image.

11. The display apparatus of claim 10, wherein the processor is configured to:
display the second indicator from a third time earlier than the first time to the first time; and
change and display one or more of a transparency, a size, a display period, a color, and a shape of the second indicator from the third time to the first time.

12. The display apparatus of claim 10, wherein the processor is configured to:
change one or more a transparency, a size, a display period, a color, and a shape of the second indicator from a fourth time, which is earlier than the second time and is later than the first time, to the second time.

13. A controlling method of a display apparatus, the method comprising:
displaying a partial area of a panorama image disposed three-dimensionally in a display;
displaying a three-dimensional map corresponding to the panorama image in the display; and
displaying a first indicator corresponding to the partial area, which is displayed in the display, in the three-dimensional map.

14. The method of claim 13, further comprising:
displaying a second indicator at a location, which corresponds to a specified coordinate of the panorama image, of the three-dimensional map.

15. The method of claim 14, wherein the displaying of the second indicator includes:
displaying the second indicator at a location, which corresponds to specified coordinate information included in information about the panorama image, of the three-dimensional map.

16. The method of claim 14, wherein the displaying of the second indicator includes:
analyzing the panorama image to verify the specified coordinate satisfying a specified condition; and
displaying the second indicator at a location, which corresponds to the specified coordinate, of the three-dimensional map.

17. The method of claim 14, further comprising:
receiving a user input to the second indicator through a user interface; and
displaying an area, which includes a coordinate corresponding to the second indicator, of an area of the panorama image in the display.

18. The method of claim 14, wherein the displaying of the second indicator includes:
displaying the second indicator from a first time to a second time based on specified time information included in information about the panorama image.

19. The method of claim 18, wherein the displaying of the second indicator includes:
displaying the second indicator from a third time earlier than the first time to the first time; and
changing and displaying one or more of a transparency, a size, a display period, a color, and a shape of the second indicator from the third time to the first time.

20. The method of claim 18, wherein the displaying of the second indicator includes:
changing one or more of a transparency, a size, a display period, a color, and a shape of the second indicator from a fourth time, which is earlier than the second time and is later than the first time, to the second time.
